(19) United States
(12) Patent Application Publication
(10) Pub. No.: US 2023/0011272 A1
(43) Pub. Date: Jan. 12, 2023

(54) APPARATUS AND METHOD WITH NEURAL PROCESSING

(71) Applicant: SAMSUNG ELECTRONICS CO., LTD., Suwon-s (KR)

(72) Inventors: Wooseok Yi, Suwon-si (KR); SANG JOON KIM, Hwaseong-si (KR)

(73) Assignee: SAMSUNG ELECTRONICS CO., LTD., Suwon-si (KR)

(21) Appl. No.: 17/571,870

(22) Filed: Jan. 10, 2022

(30) Foreign Application Priority Data
Jul. 7, 2021 (KR) 10-2021-0088834

(51) Int. Cl. G06N 3/063; G06N 3/08; G06N 3/04

(52) U.S. Cl. CPC G06N 3/063; G06N 3/08; G06N 3/049

(57) ABSTRACT

Disclosed are an apparatus and method with neural processing. The operating method includes constructing a neuron array including a plurality of neuron modules, mapping a target pattern to the neuron array, adapting the neuron modules to the target pattern in response to a reception of the target pattern, and training the neuron modules to cause the neuron array to mimic the target pattern.

### CROSS-REFERENCE TO RELATED APPLICATIONS

This application claims the benefit under 35 USC § 119(a) of Korean Patent Application No. 10-2021-0088834, filed on Jul. 7, 2021, in the Korean Intellectual Property Office, the entire disclosure of which is incorporated herein by reference for all purposes.

### BACKGROUND

### 1. Field

The following description relates to an apparatus and method with neural processing.

### 2. Description of Related Art

Neuromorphic hardware may compute numerous data in parallel in which numerous nodes transmit electrical/chemical signals in parallel for performing different activities, e.g., cognitive, recognition, conscious, etc. Existing von Neumann-type hardware, which may sequentially processes input data, showed performance in simple numerical calculations or execution of precisely written programs, but due to structural constraints such as bandwidth, have low efficiency problems in processing and understanding images or sounds for pattern recognition, real-time recognition, and speech recognition in the same way that a human analyses and understands them.

Typical neuromorphic processors have issues of excessive power consumption or a very narrow dynamic range of output.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

012052.2133

In one general aspect, an operating method of a neuron module circuit device includes constructing a neuron array including a plurality of neuron modules, mapping a target pattern to the neuron array, adapting the neuron modules to the target pattern in response to a reception of the target pattern, and training the neuron modules to cause the neuron array to mimic the target pattern.

The adapting may include activating the neuron modules in response to the reception of the target pattern and performing signal transmission between the neuron modules.

Each of the neuron modules may include any one or any combination of any two or more of a soma module, one or more axon modules, one or more synapse modules, and an external signal input/output module, and the training may include updating synaptic weights of the synapse modules.

The neuron modules may be configured to operate in any one or any combination of any two or more of a visible mode, a hidden mode, a relay mode, and a block mode, and the updating may include determining whether each of the neuron modules operates in at least one of the visible mode and the hidden mode, and updating, for each of neuron modules operating in the at least one of the visible mode and the hidden mode, the synaptic weights based on a time period from another point in time at which a spike signal is received from an adjacent neuron module to a point in time at which the corresponding neuron module outputs the spike signal.

A neuron module of the neuron modules may be configured to, when operating in the relay mode, store a direction in which the spike signal is input to the synapse module in a previous cycle, determine another direction in which the spike signal is to be transmitted in a subsequent cycle based on the direction in which the spike signal is input, and transmit the spike signal in the determined another direction.

The constructing may include determining at least one of connectivities of the plurality of neuron modules and a connection distance between the plurality of neuron modules.

The mapping may include constructing a subarray of the neuron array, and determining operation modes of the neuron modules.

The operation mode may include any one or any combination of any two or more of a visible mode, a hidden mode, a relay mode, and a block mode, and the determining may include determining an operation mode of one of neuron modules included in the subarray to be the visible mode.

The mapping may include mapping the target pattern to the one neuron module operating in the visible mode.

In another general aspect, a neuron module circuit device includes a processor configured to configure a neuron array including a plurality of neuron modules and map a target pattern to the neuron array, and the neuron array configured to adapt the neuron modules to the target pattern in response to a reception of the target pattern and train the neuron modules to mimic the target pattern.

The neuron array may be further configured to activate the neuron modules in response to the reception of the target pattern, and perform signal transmission between the neuron modules.

Each of the neuron modules may include any one or any combination of any two or more of a soma module, one or more axon modules, one or more synapse modules, and an external signal input/output module, and the neuron array may be further configured to update synaptic weights of the synapse modules.

The neuron modules may be configured to operate in any one or any combination of any two or more of a visible mode, a hidden mode, a relay mode, and a block mode, and the neuron array may be further configured to determine whether each of the neuron modules operates in at least one of the visible mode and the hidden mode, and update, for each of neuron modules operating in the at least one of the visible mode and the hidden mode, the synaptic weights based on a time period from a point in time at which a spike signal is received from an adjacent neuron module to another point in time at which the corresponding neuron module outputs the spike signal.

The neuron array may be further configured to determine at least one of connectivities of the plurality of neuron modules and a connection distance between the plurality of neuron modules.

The neuron modules may be configured to operate in any one or any combination of any two or more of a visible mode, a hidden mode, a relay mode, and a block mode, and the processor may be further configured to construct a subarray of the neuron array, determine an operation mode of one neuron module of the neuron modules included in the subarray to be the visible mode, and map the target pattern to the neuron module operating in the visible mode.

In another general aspect, a neuron module includes a synapse module, a soma module, an axon module, and an external signal input/output module, wherein the synapse module may be configured to transmit a synaptic weight value to the soma module according to an input spike signal received from a first axon module of a first adjacent neuron module, the soma module may be configured to accumulate signals received from the synapse module and the external signal input/output module, and output an output spike signal in response to a value of the accumulated signals being greater than or equal to a predetermined threshold value, and the axon module may be configured to transmit the output spike signal to a second synapse module of a second adjacent neuron module.

The soma module may include an accumulator configured to accumulate the signals received from the synapse module and the external signal input/output module, and a comparator configured to compare the value obtained by the accumulating to the threshold value.

The synapse module may include a counter configured to measure a timing for a predetermined time period from a point in time at which the input spike signal is received, and a synaptic weight updater configured to update a synaptic weight based on the timing.

The axon module may include a delay buffer configured to receive the output spike signal from the soma module and transmit the received output spike signal to the second synapse module of the second adjacent neuron module after a predetermined time period.

In another general aspect, an operating method of a neuron module circuit device includes transmiting, using a synapse module, a synaptic weight value to a soma module based on an input spike signal received from a first axon module of a first adjacent neuron module, accumulating signals received from the synapse module and the external signal input/output module, and outputting an output spike signal in response to a value of the accumulated signals being greater than or equal to a predetermined threshold value, and transmitting the output spike signal to a second synapse module of a second adjacent neuron module.

An accumulator may accumulate the signals received from the synapse module and the external signal input/output module; and a comparator may compare the value of the accumulated signals to the threshold value.

A counter may measure a timing for a predetermined time period from a point in time at which the input spike signal is received, and a synaptic weight updater may update a synaptic weight based on the timing.

A delay buffer may receive the output spike signal from the soma module and transmit the received output spike signal to the second synapse module after a predetermined time period.

Other features and aspects will be apparent from the following detailed description, the drawings, and the claims.

### BRIEF DESCRIPTION OF THE DRAWINGS

FIGS. 1A-1B illustrate an example of a system with autonomous local learning, according to one or more embodiments.

FIG. 2 is a flowchart illustrating an example of an operating method of a neuron module circuit device, according to one or more embodiments.

FIG. 3 illustrates examples of constructing a neuron array according to connectivities of a plurality of neuron modules and a connection distance between the plurality of neuron modules, according to one or more embodiments.

FIG. 4A illustrates examples of constructing a subarray, according to one or more embodiments.

FIG. 4B illustrates examples of operation modes of a neuron module, according to one or more embodiments.

FIG. 4C illustrates examples of operation modes of neuron modules constituting a subarray, according to one or more embodiments.

FIG. 4D illustrates examples of flows of signal propagation in a neuron array according to a subarray type, according to one or more embodiments.

FIG. 5 illustrates an example of a method of training neuron modules, according to one or more embodiments.

FIG. 6A illustrates an example of a neuron module. , according to one or more embodiments

FIG. 6B is a graph illustrating an example of a spike-timing-dependent plasticity (STDP) curve, according to one or more embodiments.

FIG. 6C illustrates an example of an external signal input/output module, according to one or more embodiments.

FIG. 7 is a flowchart illustrating an example of an operation algorithm of a neuron module, according to one or more embodiments.

FIG. 8 is a block diagram illustrating an example of a neuron module circuit device, according to one or more embodiments.

FIG. 9 illustrates an example of an expected effect of a neuron-centric autonomous local learning performing system, according to one or more embodiments.

FIG. 10 illustrates an example of an auxiliary spike time-series data generation simulator, according to one or more embodiments.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after understanding of the disclosure of this application may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

The example devices, apparatuses, and systems described herein may be implemented in various electronics apparatuses, such as, for example, a personal computer (PC), a laptop computer, a tablet computer, a smart phone, a television (TV), a smart home appliance, an intelligent vehicle, a kiosk, and a wearable device. Hereinafter, examples will be described in detail with reference to the accompanying drawings. In the drawings, like reference numerals are used for like elements.

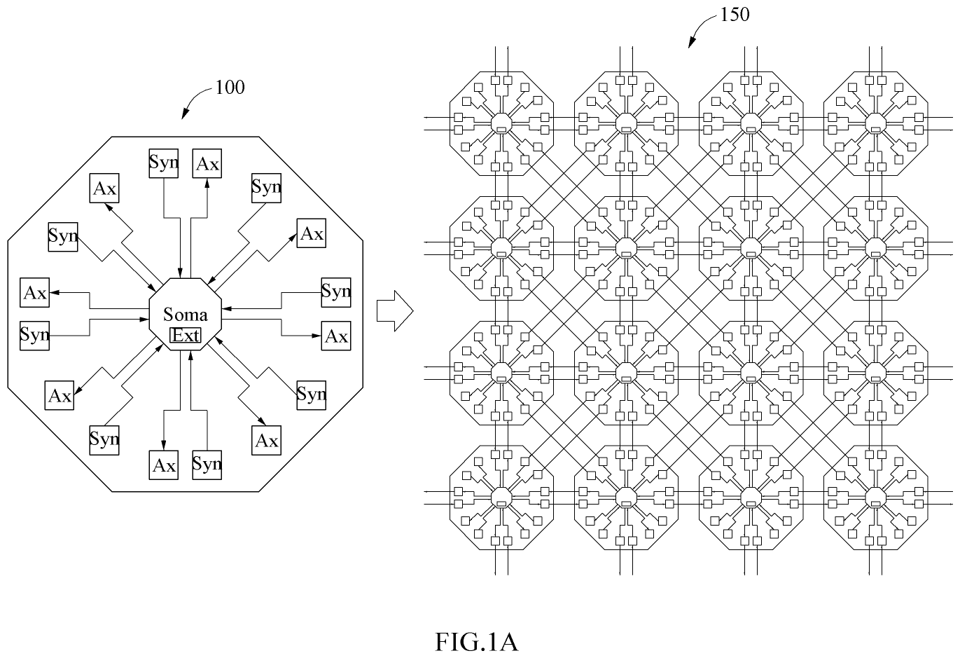

FIGS. 1A and 1B illustrate an example of a neuron-centric autonomous local learning performing system.

Referring to FIG. 1A, a system may learn time-series spike data collected (or artificially generated) by a natural neural network and attempt to copy the apparatuses, and a connection structure of the original natural neural network (or the original artificial neural network) or mimic behaviors thereof. More specifically, devices, apparatuses, and systems herein may construct an artificial neural network structure for mimicking a response (for example, time-series spike data) of a target neural network to a predetermined stimulus as it is, using only time-series firing information of some neurons measured from the natural neural network, without using information related to the number of not-measured neurons other than neurons measured in a target natural neural network and a connectivity between neurons. Hereinafter, the time-series spike data may also be referred to as a target pattern or an external signal. Herein, it is noted that use of the term “may” with respect to an example or embodiment, e.g., as to what an example or embodiment may include or implement, means that at least one example or embodiment exists in which such a feature is included or implemented while all examples and embodiments are not limited to these examples.

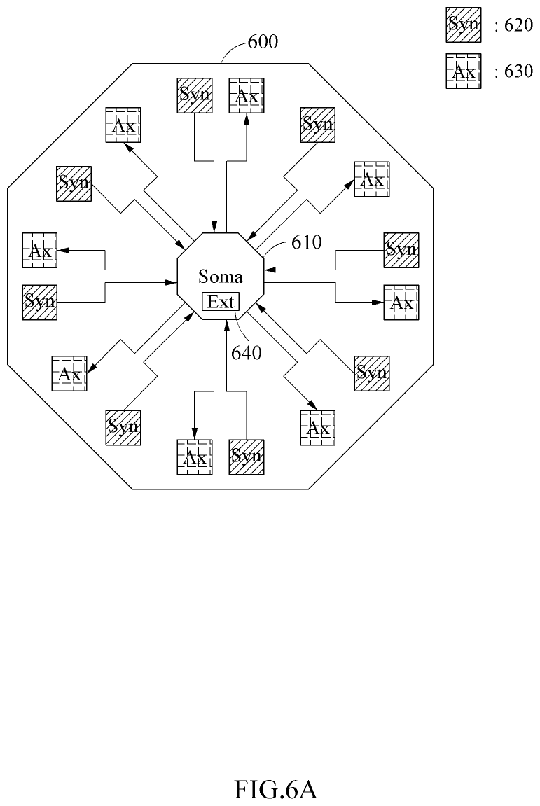

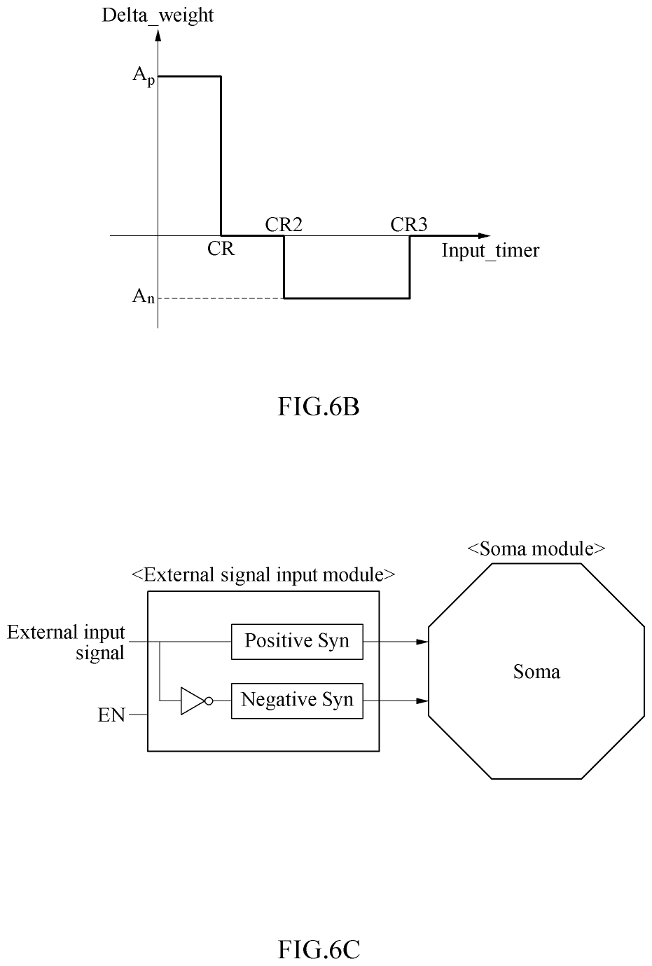

The most basic unit for configuring the system is a neuron module 100. The neuron module 100 includes one soma module, one or more (for example, eight) axon modules, and one or more (for example, eight) synapse modules. Furthermore, the neuron module 100 may further include one or more external input/output modules, one or more peripheral inhibitory input/output modules, and one or more excitatory/inhibitory synapse modules. As a non-limiting example, the modules in the neuron module 100 may operate in four phases, and the modules in the neuron may move in synchronization with each other in the same phase through an internal clock signal. The structure and operation of the neuron module 100 will be described in greater detail below with reference to FIG. 6. Herein, with respect to examples and descriptions of FIGS. 1A-10, as well as remaining examples, the Summary, and the claims, the use of the term “neuron” is not meant to mean that the “neuron” has any other meaning beyond a technological meaning, i.e., it is not meant to mean that such a term “neuron” with respect to the modules, devices, apparatuses, and systems, and corresponding applications of the same, hereinafter is structurally and operatively the same or analogous in hardware and hardware implementation with respect to chemical and neurological neuron implementations. Similarly, with the terms “neuron module”, “synapse”, “synapse module”, “axon”, “soma module” or “axon module” with respect to examples and descriptions of FIGS. 1-10, as well as remaining examples, the Summary, and the claims, the use of the terms is not meant to mean that the terms have any other meaning beyond a technological meaning, i.e., it is not meant to mean that the terms hereinafter is structurally and operatively the same or analogous in hardware and hardware implementation with respect to chemical and neurological neuron implementations of any natural neural networks described herein. For example, an artificial neural network may be hardware that is configured to have multiple layers of hardware nodes, i.e., referred as such “neurons” below.

A neuron array 150 may include a plurality of neuron modules 100. FIG. 1A shows an example of a two-dimensional neuron array 150 in which a basic neuron module having peripheral 8-way connectivity is connected to adjacent neurons at a distance of “1”. However, the configuration of the neuron array 150 is merely an example and should not be construed as limiting or defining the scope of other examples. Accordingly, a neuron array may have various connectivities and connection distances, and may be configured one-dimensionally, two-dimensionally, or three-dimensionally.

The neuron modules in the neuron array 150 may receive the same global clock and move in synchronization. Each neuron module in the neuron array 150 may operate independently by exchanging a spike signal of “0” or “1” with neighboring neurons. In addition, input signals provided from the outside may also be individually received through a method using WL/BL selection or a shift register, which allows each or some of the neuron modules of the neuron array 150 to be synchronized to an external signal to regulate expression timings.

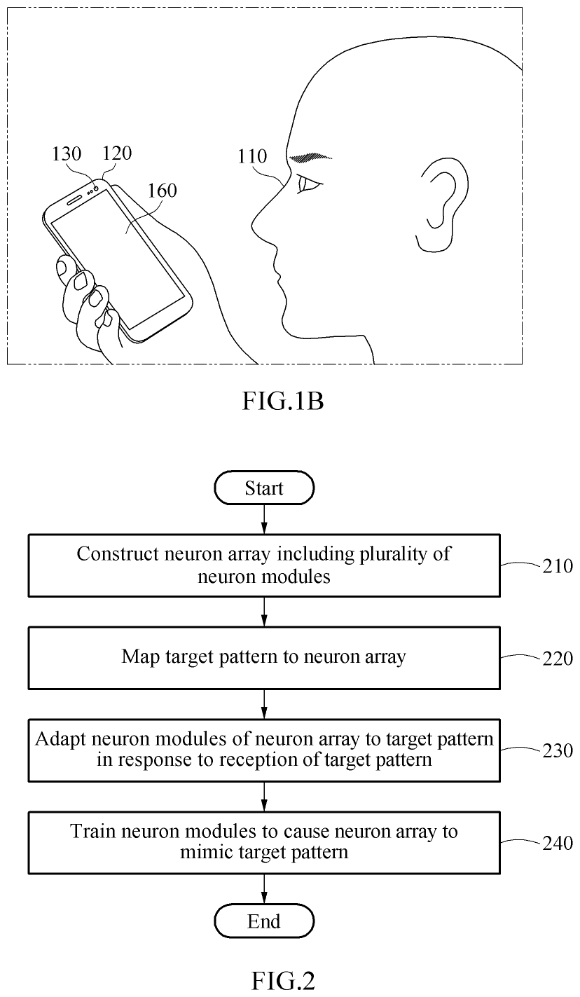

The system may map target spike time-series data to be learned to the neuron array 150 and then, train the neuron modules to cause the neuron array 150 to mimic the target spike time-series data. A non-limiting example of the training method of the system will be described in greater detail below with reference to FIGS. 2 to 5. The method of the neuron device, apparatus, and system may be performed as a processor-implimented method.

FIG. 1B illustrates an example of a neuron-centric autonomous local learning performing system, e.g., as an example smartphone, which may further include a user 110 using the smartphone 120, microphone 130, and display 160.

FIG. 2 is a flowchart illustrating an example of an operating method of a neuron module circuit device, according to one or more embodiments.

Referring to FIG. 2, operations 210 to 240 may be performed by a neuron module circuit device. The neuron module circuit device may be implemented by one or more hardware modules, one or more software modules, or various combinations thereof.

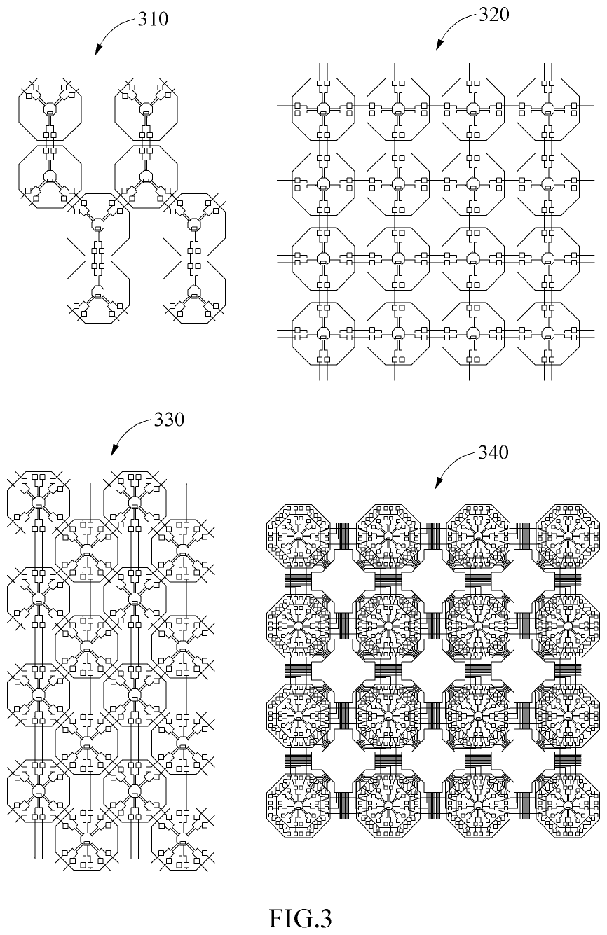

In operation 210, the neuron module circuit device configures a neuron array including a plurality of neuron modules. In addition, the neuron module circuit device may determine at least one of the connectivities of the plurality of neuron modules constituting the neuron array and a connection distance between the plurality of neuron modules. Hereinafter, the example of constructing the neuron array will be described in greater detail below with reference to FIG. 3, according to one or more embodiments.

FIG. 3 illustrates examples of constructing a neuron array according to connectivities of a plurality of neuron modules and a connection distance between the plurality of neuron modules.

Referring to FIG. 3, the neuron module circuit device may construct neuron arrays in various aspects by determining at least one of the connectivities of the plurality of neuron modules and the connection distance between the plurality of neuron modules.

A connectivity of a neuron module may refer to the number of adjacent neurons connected to the corresponding neuron, and a connection distance between neuron modules may be the maximum distance at which one neuron module is connected to an adjacent neuron module.

For example, a neuron array 310 may include neuron modules that have 3-way connectivity and are configured at a connection distance of “1.” A neuron array 320 may include neuron modules that have 4-way connectivity and are configured at a connection distance of “1”. A neuron array 330 may include neuron modules that have 6-way connectivity and are configured at a connection distance of “1”. A neuron array 340 may include neuron modules that have 8-way connectivity and are configured at a connection distance of “2”.

Each of the neuron modules constituting the neuron array 340 may be connected to a total of 24 neurons in a 5×5 grid. That is, neuron modules with a connection distance of “2” may be connected to more neurons and thus learn more various input patterns when compared to neuron modules with a connection distance of “1”.

Although FIG. 3 shows the neuron arrays 310 to 340, each including neuron modules having the same connectivity. A neuron array may also be configured using neuron modules having different connectivities.

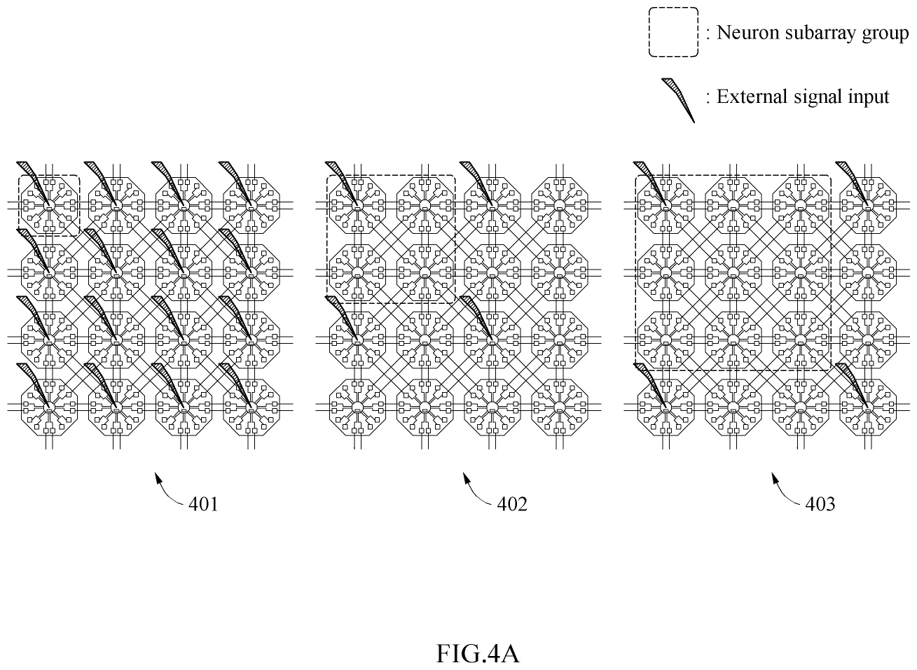

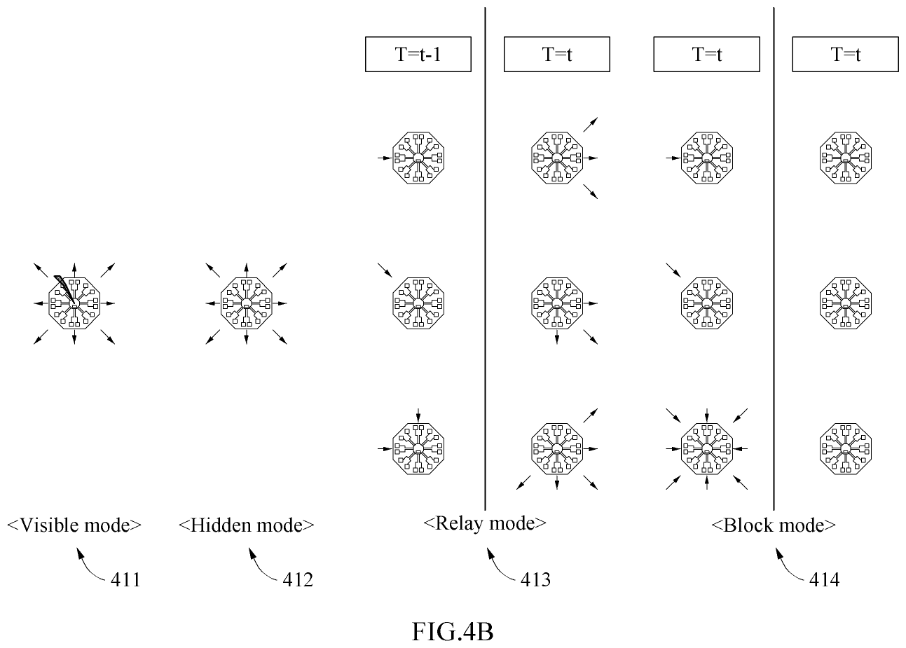

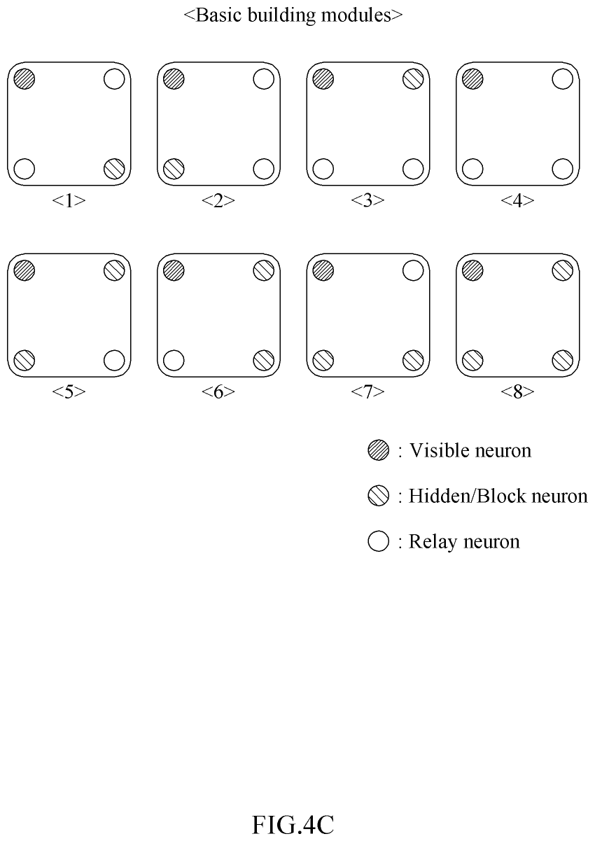

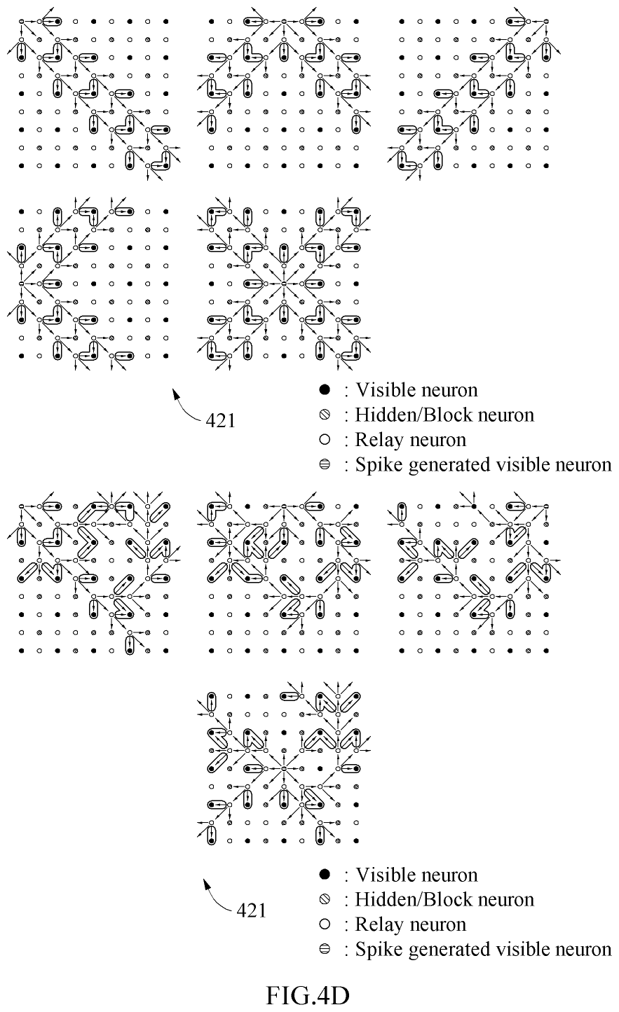

Referring back to FIG. 2, in operation 220, the neuron module circuit device maps a target pattern to the neuron array. More specifically, the neuron module circuit device may configure a subarray of the neuron array and determine the operation modes of the neuron modules. For example, the operation modes of the neuron modules may include any one or any combination of a visible mode, a hidden mode, a relay mode, and a block mode. The neuron module circuit device may determine an operation mode of one of the neuron modules included in the subarray to be the visible mode, and map the target pattern to the neuron module operating in the visible mode. The example of mapping the target pattern to the neuron array will be described in greater detail below with reference to FIGS. 4A to 4D.

FIG. 4A illustrates examples of constructing a subarray, according to one or more embodiments.

Referring to FIG. 4A, one or more neuron modules in a neuron array may be grouped into a subarray group. A subarray group may include one or more neuron modules, such as N×N neuron modules (N being an integer) such as 1×1, 2×2, and 3×3 neuron modules, or N×M neuron modules (N and M each being an integer) such as 1×2, 2×1, and 2×3 neuron modules, wherein one subarray group may correspond to one time-series spike data (external signal).

For example, a subarray of a neuron array 401 may have a size of 1×1, a subarray of a neuron array 402 may have a size of 2×2, and a subarray of a neuron array 403 may have a size of 3×3. The examples of the operation modes of the neuron modules will be described in greater detail below with reference to FIG. 4B.

FIG. 4B illustrates examples of operation modes of a neuron module, according to one or more embodiments.

Referring to FIG. 4B, a neuron module may operate in a visible mode 411, a hidden mode 412, a relay mode 413, or a block mode 414. In the visible mode 411, the neuron module may fire a signal by accumulating, at a soma module, signals received from neighboring neuron modules through synapse modules or external signals received from an external input/output module, and transmit the fired signal back to the neighboring neurons through axon modules or transmit a firing result to the external input/output module.

In the hidden mode 412, the neuron module may be in a neuron mode in which it is invisible from the outside, and perform the same operation as in the visible mode in terms of function except that the external input/output module does not function.

In the relay mode 413, the neuron module may memorize a direction in which a spike signal is input to a synapse module in a previous cycle, determine a direction in which the spike signal is to be transmitted in a subsequent cycle based on the direction in which the spike signal is input, and transmit the spike signal in the determined direction.

For example, the neuron module operating in the relay mode 413 may memorize the direction in which the spike signal is input to the synapse module in the previous cycle, and propagate the signal from axon modules of three directions farthest from the direction to a subsequent neuron module in the subsequent cycle. Furthermore, if signals are simultaneously input to the neuron module operating in the relay mode 413 from two directions, the spike signals may be transmitted in three farthest directions for each of the two signals. In this case, the three directions may overlap each other, but the intensities may not be changed.

In the block mode 414, the neuron module may not be in expression any longer even when an input is received from the outside, thereby blocking unlimited signal propagation by a neuron module operating in the relay mode 413.

Referring back to FIG. 4A, the neuron module circuit device may determine an operation mode of one of neuron modules included in the subarray to be the visible mode, and map the target pattern to the neuron module operating in the visible mode. That is, only the neuron module operating in the visible mode may receive the time-series spike data (external signal) from the external input/output module.

For example, only a first neuron module (for example, the first neuron module from the left in the uppermost row) of the neuron modules in the subarray group may receive the time-series spike data (external signal) and operate, and the remaining neuron modules may receive signals from adjacent neuron modules. Although FIG. 4A shows the first neuron module from the left in the uppermost row operating in the visible mode for ease of description, the neuron module operating in the visible mode may be arbitrarily selected from among the neuron modules included in the subarray.

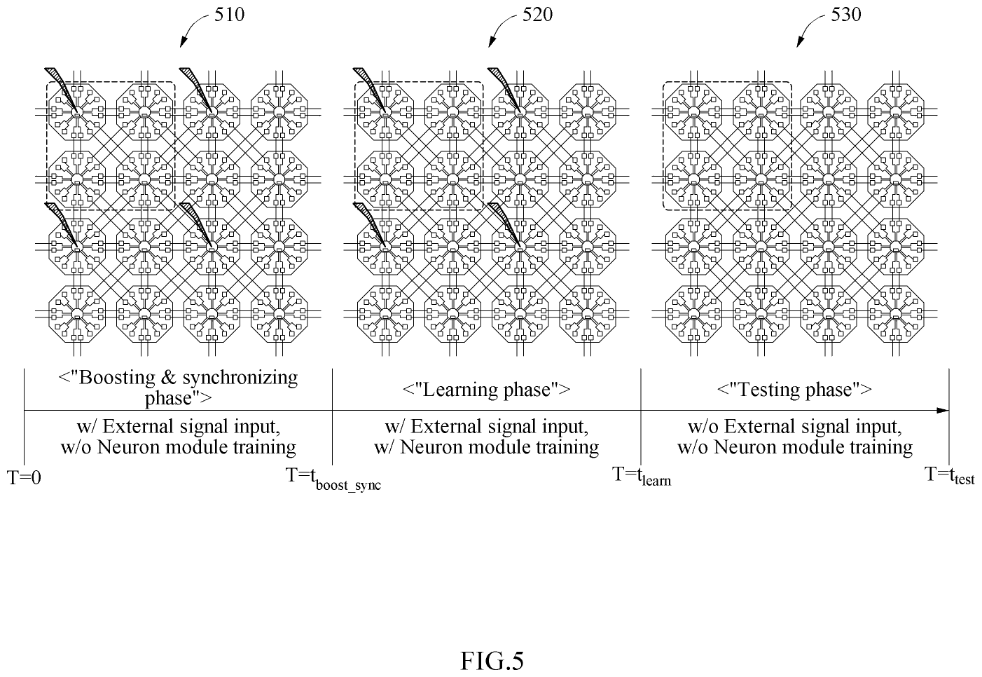

When the neuron module operating in the visible mode receives an external signal and operates, then the corresponding neuron module may be synchronized to the external signal to regulate an expression timing since a synaptic weight with the external signal input/output module is set to be very great compared to a synaptic weight of a synapse module that receives a signal from another neuron. This will be described in greater detail below with reference to FIG. 5.

FIG. 4C illustrates examples of operation modes of neuron modules constituting a subarray, according to one or more embodiments.

Referring to FIG. 4C, in the case of constructing a 2×2 subarray group, a total of eight types of subarray groups may be generated. (However, in the case of generating a subarray group discriminatively for a hidden mode and a block mode, much more types of subarray groups may be generated.)

For example, a first neuron module (the first neuron module from the left in the uppermost row) may be fixed to be in a visible mode, and an external signal may be input to this neuron module. The remaining neuron modules in a subarray group may be set to be in a relay mode or a hidden/block mode. The neuron array may be configured by only a predetermined type selected from such neuron subarrays or by a combination of random types. Hereinafter, flows of signal propagation in a neuron array according to a subarray type will be described with reference to FIG. 4D.

FIG. 4D illustrates examples of flows of signal propagation in a neuron array according to a subarray type.

Referring to FIG. 4D, a neuron array 421 may be configured by only 2×2 subarrays of Type <1>of FIG. 4C in five rows and five columns, and include a total of 9×9 neuron modules by excluding the rightmost column of neuron modules and the lowermost row of neuron modules. In this neuron array, when a predetermined neuron generates a spike signal, the signal may be propagated to a subsequent neuron module, one neuron module by one neuron module, for each clock cycle. Since all the subarrays are of the same type, signals may be propagated in a regular and symmetrical form according to the position of a neuron module that is in expression. The signals input to each neuron module are enclosed by a solid line around each neuron module.

A neuron array 422 may be configured by random combinations of 2×2 subarrays in five rows and five columns. In this case, signals of various different patterns may be propagated according to the expression positions of neurons.

Referring back to FIG. 2, in operation 230, the neuron module circuit device may receive the target pattern and adapt the neuron modules of the neuron array to the target pattern. More specifically, before the neuron module circuit device trains the neuron array, the neuron array may adapt to the target pattern and prepare for training. The neuron module circuit device may receive the target pattern to prepare for training, activate each of the neuron modules, and perform signal transmission between the neuron modules.

In operation 240, the neuron module circuit device may train each of the neuron modules to cause the neuron array to mimic the target pattern. More specifically, the neuron module circuit device may update synaptic weights of synapse modules. The neuron module circuit device may determine whether each of the neuron modules operates in at least one of the visible mode and the hidden mode, and update, for each of neuron modules operating in at least one of the visible mode and the hidden mode, the synaptic weights based on a time period from a point in time at which a spike signal is received from an adjacent neuron module to a point in time at which the corresponding neuron module outputs a spike signal. The method for training preparation and training will be described below with reference to FIG. 5.

FIG. 5 illustrates an example of a method of training neuron modules, according to one or more embodiments.

Referring to FIG. 5, a neuron module circuit device may continuously input external signals to neuron modules operating in a visible mode in each subarray group for each timestep during a boosting and synchronizing phase 510, but all neuron modules may repeat only an accumulation-expression-initialization process simply according to the signal transmission without learning synaptic weights.

The boosting and synchronizing phase 510 is performed for the following reason. Basically, spikes are generated respectively by a pre-synaptic neuron and a post-synaptic neuron, and STDP learning is performed based on a time difference between the two spikes. When the training of a neuron module operating in a visible mode and adjacent neuron modules thereof is started in a state in which a neuron array does not sufficiently adapt to a corresponding pattern in an early stage, not “normal directional” training that the neuron module operating in the visible mode is in expression in response to a reception of a signal from an adjacent neuron module, but “backward learning” that a pattern fired by an adjacent neuron module is learned due to a firing of the neuron module operating in the visible mode may be performed.

That is, the originally intended training is training while gradually reinforcing neighboring neuron modules having any effect on the neuron module operating in the visible mode before a firing by the neuron module operating in the visible mode by forcing “a firing timing” of the neuron module operating in the visible mode through a target pattern. However, if the boosting and synchronizing phase 510 is not performed, opposite the intended training direction, training in a direction that a firing by the neuron module operating in the visible mode causes the neighboring neuron modules connected thereto to fire, that is, training in a direction in which the pre-post relationship is reversed, is highly likely to be reinforced.

After the neuron array is familiar with the target pattern through the boosting and synchronizing phase 510 (T>_(boost_sync)), the neuron module circuit device starts training each neuron module through a learning phase 520. In the learning phase 520, neuron modules operating in the visible mode fire at timings according to the target pattern, and synaptic weight values in synapse modules of adjacent neurons respectively increase or decrease according to the firing times from the corresponding firing timings.

The neuron module circuit device may update the synaptic weight values through STDP learning. Synapse modules in a neuron module have one synaptic weight value, and the neuron module circuit device may change the synaptic weight value by utilizing a firing timing of a connected neuron module and a firing timing of the neuron module, including the synapse modules as input through STDP learning. Depending on the implementation, the synaptic weights may be changed by a predetermined value through a simple comparator or may be selected from several values according to a difference in firing timing through a look-up table (LUT) scheme. That is, the weight update of the synaptic modules may occur by itself through only signal transmission between a neuron and an adjacent neuron.

After learning for a predetermined period of time is finished (T>t_learn), the neuron module circuit device may let the neuron array oscillate by itself while not inputting an external signal any more and not training the neuron modules any more in a testing phase 530. Furthermore, during the testing phase 530, the neuron module circuit device may compare a firing pattern of representative neuron modules of the neuron array with a firing pattern of corresponding neurons of a target pattern, and compare learning accuracies by counting true positive (Target neuron: Fire, Visible neuron: Fire) values and true negative (Target neuron: Not fire, Visible neuron: Not fire) values for each timestep.

FIG. 6A illustrates an example of a neuron module, according to one or more embodiments.

Referring to FIG. 6A, a neuron module 600 may include one soma module 610, one or more synapse modules 620, and one or more axon modules 630.

The neuron module 600 may perform operations such as initialization, activation, and mode setting, and the activation operation may include accumulation, expression, and update operations.

The initialization operation may be an operation of initializing the soma module 610, the synapse modules 620, the axon modules 630, and an external signal input/output module 640 included in the neuron module 600 and connecting inputs of the synapse modules and outputs of axon modules of adjacent neuron modules to the neuron module 600.

The activation operation may be an operation performed in circulation of three operations: accumulation, expression, and update. For example, the accumulation operation may be an operation of setting the synapse modules 620 as activators and the soma module 610 as an accumulator such that the outputs from the synapse modules 620 and the external signal input/output module 640 may be accumulated in the soma module 610.

The expression operation may be an operation of setting the soma module 610 as an activator and the synapse modules 620 as deactivators and, if a mode of the neuron module 600 is other than a relay mode, setting the axon modules 630 as activators. If the mode of the neuron module 600 is the relay mode, it may be set to activate axon modules 630 of three farthest directions, for neuron modules receiving spike signals from adjacent neuron modules, of the synapse modules 620.

The update operation may be an operation of setting synapse modules 610 in the neuron module 600 as updators to update synaptic weights, if a training mode of the neuron module 600 is active and the mode of the neuron module 600 is a visible mode or a hidden mode.

The mode setting operation may be an operation of setting modes of detailed modules according to the mode state of the neuron module 600.

The neuron module 600 may receive spike signals (for example, “0” or “1”) from adjacent neuron modules through the synapse modules 620, accumulate all synaptic output values through the soma module 600, then fire according to a threshold value, transmit the fired result value back to the adjacent neurons through the axon modules 630, and then have a refractory period. In the refractory period, even when spike signals are input from adjacent neuronal modules, the spike signals may not be accumulated in the soma, which mimics an “absolute refractory period” of biological neurons, fo example, for which the neurons do not respond to external signals until the concentrations of sodium/potassium ions inside/outside of cells are recovered after spikes are generated as the two ion concentrations are reversed. In addition, the value of an accumulation buffer in the soma module 610 of the neuron module 600 that has fired may be set to be less than or equal to “0” that is less than an initial value after expression, which mimics a “relative refractory period” in which a greater stimulus than before is needed to cause another expression immediately after an expression.

The soma module 610 may include a refractory period timer module (Refractory_timer), an accumulation buffer module (Accum_buffer), and registers for storing a threshold value (Threshold), an accumulation decay (decay), a refractory period initial value (Refractory period), an accumulation butter initial value (buf_init_value), an accumulation buffer minimum value (accum_min), an output (fire), and a mode (mode).

In the accumulation operation, the soma module 610 may accumulate outputs of all the synapse modules 620 and the external signal input/output module 640 in the accumulation buffer, if the neuron module 600 is not in a block mode and refractory_timer=0. If a cumulative value in an output buffer is less than the accumulation buffer minimum value (accum_min), the soma module 610 may not accumulate the outputs of all the synapse modules 620 and the external signal input/output module 640 any further. If refractory_timer>0, the soma module 610 may not accumulate the outputs of the synapse and external signal input/output module modules in the accumulation buffer (accum_buffer) at the corresponding clock.

In the expression operation, if refractory_timer=0 and the cumulative value in the output buffer is greater than the threshold value, the soma module 610 may set an output of the soma module 610 to “1” (for example, set Fire=1), set the cumulative value in the output buffer as the accumulation buffer initial value (buf_init_value)(≤0), and set the refractory period timer (refractory_timer) value as the refractory period initial value. If refractory_timer>0, the soma module 610 may decrease the refractory period timer (refractory_timer) value by “1”.

In the mode setting operation, if the mode input is designated as a relay mode, the soma module 610 may set the accumulation buffer minimum value to “0”, set the refractory period initial value to “0”, and set the threshold value to “1”. In the other modes, the soma module 610 may set the accumulation buffer minimum value, the refractory period initial value, and the threshold value to be default values.

The synapse modules 620 may include an input timer (input_timer) module, and registers for storing a synaptic weight (weight), a weight maximum (w_max), a weight minimum (w-min), a some output (fire), an input timer maximum value (input_timer_max), synapse module input/output (synapse_input and synapse_output), parameters A_p, A_n, CR, and CR2 related to STDP learning, a learning rate (learning_rate), a weight decay (decay), and a mode (mode).

In the initialization operation, the synapse modules 620 may randomly set the initial values of synaptic weights to be a value between the weight minimum and the weight maximum if the mode of the synapse modules is not “constant”, and fix the values of the synaptic weights to be “1” if the mode is “constant”.

In the expression operation, when the synapse mode is other than a relay mode, the synapse modules 620 may set synapse module outputs to be the synaptic weights and the input timer (input_timer) to “1” if a synapse module input is “1”, increase the input timer value by “1” if the synapse module input is “0” and 0<input_timer<input_timer_max, and set the input timer value to “0” if input_timer=input_timer_max.

In the update operation, as expressed by Equation 1, the synapse modules 620 may obtain a delta weight (delta_weight) and add the delta weight to the weights using update functions determined according to an input timer state, when the soma output value is “1”.

(0<input_timer≤CR1) delta_weight=learning_rate*A_p (input_timer>CR2) delta_weight=learning_rate*A_n Input_timer=0 [Equation 1]

If a soma output value is “0”, the synapse modules 620 may have synaptic weights that decay according to a timing at which the input value is input, and obtain a delta weight and add the delta weight to the weights, as expressed by Equation 2.

delta_weight=−learning_rate*synapse_decay*input_timer [Equation 2]

That is, the synapse modules 620 may measure the input timer value fora predetermined time from a point in time at which the input spike signal (Fire=1) is input and, when the soma module 610 is in expression (Fire=1), update their synaptic weight values according to the input timer value at that time.

FIG. 6B is a graph illustrating an example of a spike-timing-dependent plasticity (STDP) curve.

Referring to FIG. 6B, an update of synaptic weights may be performed with an eHB-STDP curve in which only the most basic pre-than-post learning is simplified for resource simplification in hardware implementation, and parameter values of the graph may be stored respectively in registers in the synapse modules 620. However, the STDP curve is merely an example for helping to understand and should not be construed as limiting or defining the scope of other examples. Accordingly, the synaptic weight values may be updated using various types of STDP curves.

Referring back to FIG. 6A, the axon modules 630 may each include an input FIFO buffer (axon_input) module, and registers for storing a transmission delay (delay) and an output value (axon_output).

The axon modules 630 may each have an input FIFO buffer with a length of “0” to “4”, and input a fire signal received from the soma module in each cycle in the activation operation to the input FIFO buffer and transmit an output of the input FIFO buffer to an output (axon_output) thereof for each cycle.

The neuron module 600 may further include the external signal input/output module 640. The external signal input/output module 640 may include a positive synapse module, a negative synapse module, an inverter module, and registers for storing input/output signals.

The external signal input/output module 640 may input a spike signal input from the outside and an inverted signal thereof to the positive synapse module and the negative synapse module, respectively, and transmit outputs from the two synapse modules back to the soma module 610 in the neuron module 600. In addition, the output (fire) signal of the soma module 610 may be stored in the internal register after an expression period so as to be read from the outside.

FIG. 6C illustrates an example of an external signal input/output module, according to one or more embodiments.

Referring to FIG. 6C, the external signal input/output module 640 may include two synapse modules, a positive synapse module and a negative synapse module. The positive synapse module may have a very large synaptic weight greater than or equal to a threshold value to allow the soma module to be immediately in expression when an external input signal is “1” and conversely, have a very small synaptic weight to prevent an expression of the soma module when an external input signal is “0”.

The external signal input/output module 640 may adjust its output in response to a reception of an activation (EN) signal. When an external signal is not input to the neuron module 600 any further, the external signal input/output module 640 may turn off the activation signal to allow the neuron module 600 to operate again while exchanging signals with neighboring neurons.

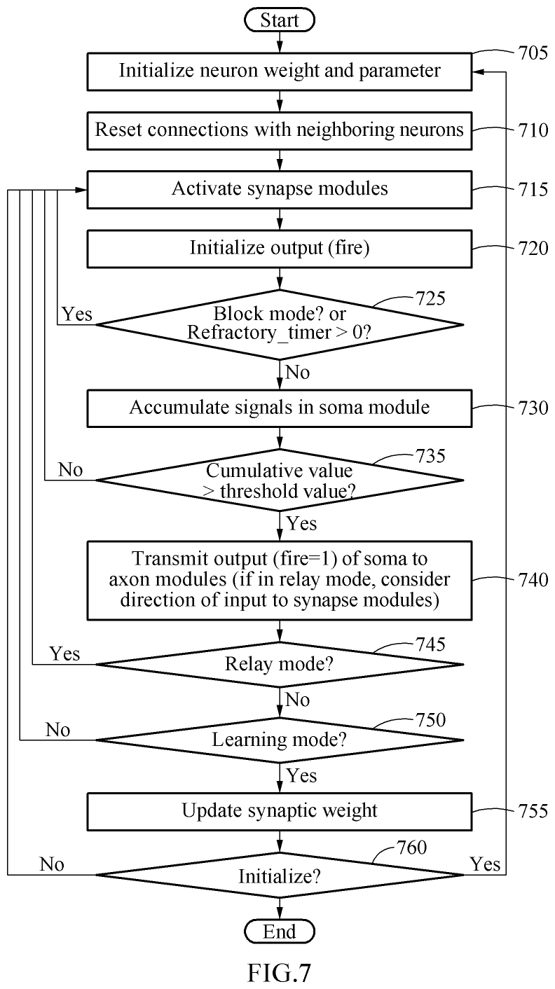

FIG. 7 is a flowchart illustrating an example of an operation algorithm of a neuron module, according to one or more embodiments.

Referring to FIG. 7, operations 705 to 760 may be performed by a neuron module circuit device. The description provided with reference to FIGS. 1 to 6C may also apply to the example of FIG. 7, and thus, a duplicate description will be omitted.

In operation 705, the neuron module circuit device may initialize a neuron weight and a parameter of a neuron module.

In operation 710, the neuron module circuit device may reset connections with neighboring neuron modules.

In operation 715, the neuron module circuit device may activate synapse modules of the neuron module.

In operation 720, the neuron module circuit device may initialize an output signal (fire).

In operation 725, the neuron module circuit device may determine whether the neuron module is in a block mode or whether a refractory period timer is greater than “0”. If not, the neuron module circuit device may accumulate signals in a soma module, in operation 730.

In operation 735, the neuron module circuit device may compare a cumulative value to a threshold value. If the cumulative value is greater than the threshold value, the neuron module circuit device may transmit an output (fire=1) signal of the soma of the neuron module to axon modules, in operation 740.

In operation 745, the neuron module circuit device may determine whether the neuron module is in a relay mode. In response to the determination that the neuron module is not in the relay mode, the neuron module circuit device may determine whether the neuron module is currently in a learning mode, in operation 750.

In operation 755, the neuron module circuit device may update a synaptic weight if the neuron module is currently in the learning mode. In operation 760, the neuron module circuit device may initialize the neuron module.

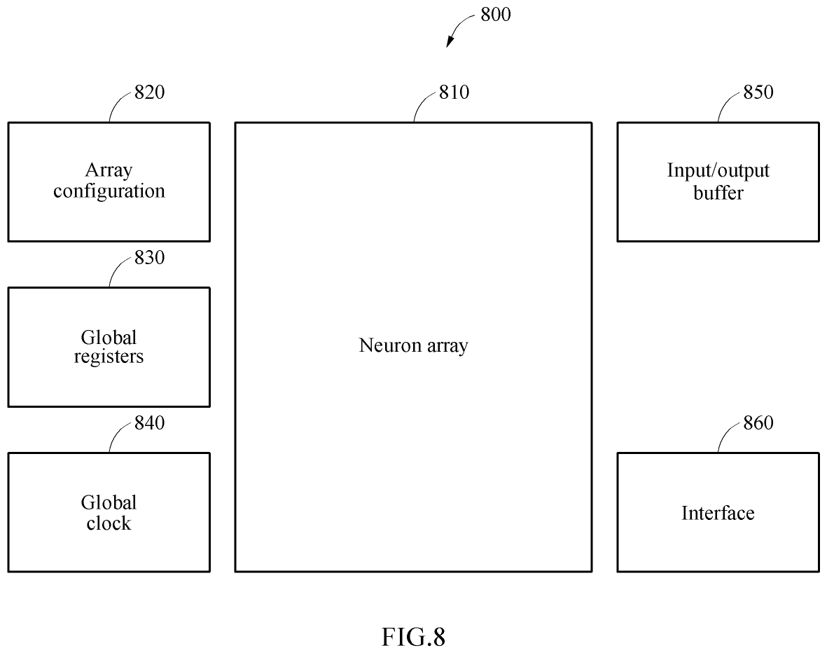

FIG. 8 is a block diagram illustrating an example of a neuron module circuit device, according to one or more embodiments.

Referring to FIG. 8, a neuron module circuit device 800 may include a neuron array 810, an array configuration 820, a global register 830, a global clock 840, an input/output buffer 850, and an interface 860.

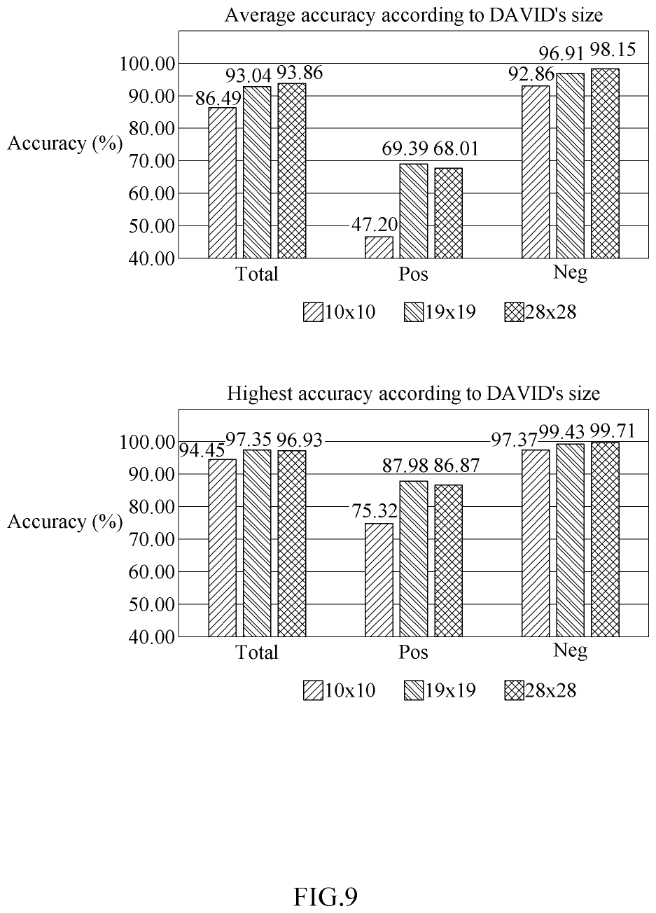

FIG. 9 illustrates an example of an expected effect of a neuron-centric autonomous local learning performing system, according to one or more embodiments.

Learning on a natural neural network or arbitrary spike time-series data mimics the neural network's behavior or artificial neural network structure. As simulation learning results, average value and maximum value results of true positive, true negative, and total true accuracies measured after 100-time training of systems respectively including 10×10 (subarray size: 1×1), 19×19 (subarray size: 2×2), and 28×28 (subarray size: 3×3) neuron modules, with arbitrary time-series data showing periodicity of N_n=100, sparsity=0.5, and T=4 cycles generated by a spike time-series generator are shown in FIG. 9.

Referring to FIG. 9, for an arbitrary periodicity pattern generated by the network including 100 neurons, the 19×19 DAVID system shows a relatively high learning efficiency compared to the increasing resource usage according to the increasing number of neurons. Considering the true positive, which is the accuracy of spikes that are actually fired, instead of the true negative that is maintained relatively high due to sparse spike patterns, the 19×19 system shows much higher true positive accuracy (average 69.39%, maximum 87.98%) than the accuracy (average 68.01%, maximum 86.87%) of the 28×28 system (True negative generally increases as the size of the neuron array increases, which may cause distortion in the results).

Therefore, the optimal subarray size for learning the arbitrary periodicity pattern under the given condition may be determined to be “2×2”. Comparing the results with those for copying using a crossbar array, the number of synapse elements requiring learning is 100×100=10,000 when the size of a crossbar array required to copy a firing pattern of 100 target neurons is 100×100. In the case of a system proposed herein, the number of synapse elements requiring training on 19×19=361 neuron modules is 361×8−3×17×4−5×4=2,664, if synapse elements on the edge of the neuron array are excluded.

Accordingly, the number of synapse elements required for the proposed system to copy an arbitrary 10×10 natural neural network may be 73.36% less than that for the crossbar array. The synapse element reduction effect of the proposed system may increase as the size of the target natural neural network increases. For example, the number of synapse elements required for the crossbar array to copy an arbitrary 20×20 natural neural network is 160,000, whereas the proposed system may require 11,704 (92.7% reduced) synapse elements if the subarray size is 2×2, and 26,220 (83.6% reduced) synapse elements if the subarray size is 3×3. Although the proposed system may reduce accuracy as the size increases or the pattern aperiodicity increases, a structural improvement utilizing an additional parameter adjustment and a genetic algorithm may lead to an additional performance improvement.

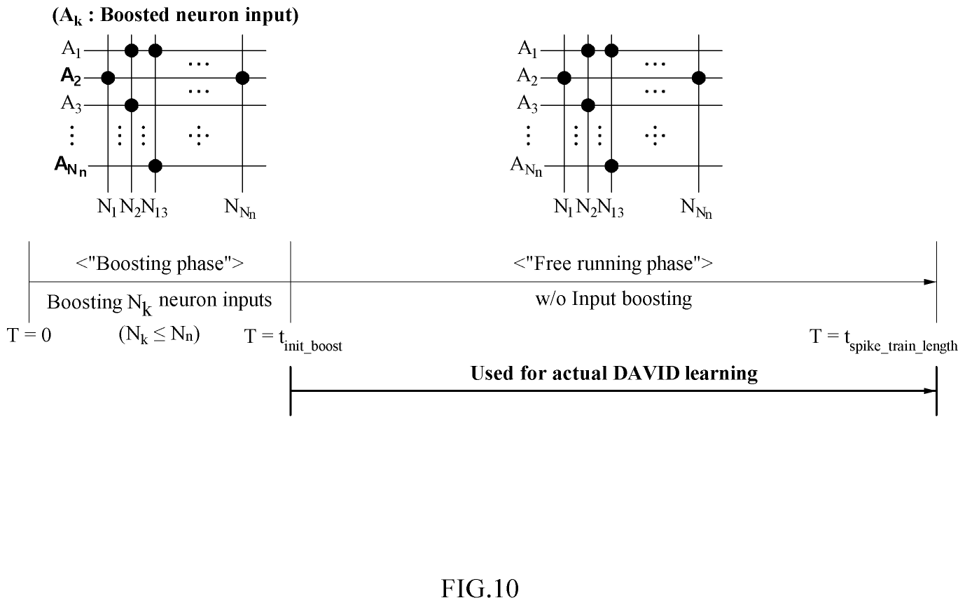

FIG. 10 illustrates an example of an auxiliary spike time-series data generation simulator, according to one or more embodiments.

It is basically assumed that a neuron array receives, as an external signal, spike time-series data collected from biological tissues or neurons. However, the neuron array may also receive spike time-series data having an arbitrary pattern that is artificially generated.

In general, spike time-series data consecutive for a long time are needed to train a system with high accuracy. However, it is not easy for the measurement schemes up to now to collect spike data of a number of cells for a long time, and in some cases, a measured signal shows one-time spike time-series data that do not continuously oscillate without having a periodicity.

Therefore, smooth training of the system may require an auxiliary spike time-series data generation simulator (for example, a spike train generator) for generating artificial spike time-series data to supplement incomplete spike time-series data or perform pre-training of the system.

To verify in advance whether the system may copy signals generated by a biological neural network having arbitrary connectivity, the spike time-series generator may operate as follows.

First, when the number of spiking neurons constituting the network is N_n, the spike time-series generator may generate an N_n×N_n random synaptic weight matrix W, as expressed by Equation 3.

$$[ \begin{matrix}{w}_{1 , 1} & {w}_{1 , 2} & {w}_{1 , 3} & … & {w}_{1 , Nn} \\ {w}_{2 , 1} & {w}_{2 , 2} & {w}_{2 , 3} & … & {w}_{2 , Nn} \\ {w}_{31} & {w}_{32} & {w}_{3 , 3} & … & {w}_{3 , Nn} \\ ⋮ & ⋮ & ⋮ & & ⋮ \\ {w}_{Nn , 1} & {w}_{Nn , 2} & {w}_{Nn , 3} & … & {w}_{N , ι , N , ι}\end{matrix} ] \to [ \begin{matrix}0 & {w}_{1 , 2} & {w}_{1 , 3} & … & {w}_{1 , Nn} \\ {w}_{2 , 1} & 0 & {w}_{2 , 3} & … & {w}_{2 , Nn} \\ {w}_{3 , 1} & {w}_{3 , 2} & 0 & … & {w}_{3 , Nn} \\ ⋮ & ⋮ & ⋮ & & ⋮ \\ {w}_{Nn , 1} & {w}_{Nn , 2} & {w}_{Nn , 3} & … & 0\end{matrix} ] \to [ \begin{matrix}0 & {w}_{1 , 2} & {w}_{1 , 3} & … & 0 \\ {w}_{2 , 1} & 0 & 0 & … & {w}_{2 , Nn} \\ 0 & {w}_{3 , 2} & 0 & … & 0 \\ ⋮ & ⋮ & ⋮ & & ⋮ \\ 0 & 0 & {w}_{Nn , 3} & … & 0\end{matrix} ] \qquad [ Equation 3 ]$$

Row indices of the synaptic weight matrix W may be inputs of respective neurons, and column indices thereof may be the respective neurons. The range of random values for generating synaptic weights may follow the range of values that are pre-designated. The spike time-series generator may additionally receive a sparsity value in the range of “0” to “1” and adjust non-zero values in the synaptic weight matrix accordingly. For example, if sparsity=0.9 is set, the spike time-series generator may first set an element value (W_(i.i) for i=‘integer’) connected to itself to “0” (because in general, neurons having synapses connected to themselves die by themselves), and filter the remaining elements such that a ratio of arbitrary non-zero values of all the elements is 1−0.9=0.1. The synaptic weight matrix generated through the foregoing may represent a sparse network having only 10% of the total possible connectivity.

Then, the spike time-series generator may extract spike time-series from the generated network, by performing a task of boosting the network at an early stage, as shown in FIG. 10, (“Boosting phase”).

The spike time-series generator may randomly select N_k (k≤n) neurons from among all N_n neurons, and apply an appropriate bias to inputs of the selected neurons. Then, the neurons may start to generate spike outputs over time, and transmit the signals to subsequent neurons connected thereto according to generated synaptic weight values.

The spike time-series generator may perform boosting on N_k inputs for a predetermined initial time (t_(init_boost)) in this way, then collect spike train data for each timestep while releasing input boosting and allowing the network to oscillate in freedom (“free running phase”), and train the system using the data collected in this way.

Here, in the free running phase, the network may show two aspects. In the first aspect, the network may continuously generate spike train data for a long time (˜t_(spike_train_length)) without any issue. In this case, the network may determine that “a self-oscillating network” appropriate for learning is formed through the system, and store corresponding spike time-series data and then, use the data for learning.

In the second aspect, the network may not generate spike train data any further after a predetermined time after the input boosting is turned off as the boosting phase ends. This happens more frequently when the number of neurons constituting the network is remarkably small or when the sparsity is remarkably high compared to the number of neurons. In this case, it is impossible to collect spike train data as much as to be used for learning any further. Thus, the process may move back to the first operation of generating a random synaptic weight matrix again.

The neuron module circuit device, neuron array, neuron modules, synapse module, soma module, axon module, external signal input/output module, neuron module circuit device 800, neuron array 810, array configuration 820, global register 830, global clock 840, input/output buffer 850, and interface 860 in FIGS. 1A-10 that perform the operations described in this application are implemented by hardware components configured to perform the operations described in this application that are performed by the hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1A-10 that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions in the specification, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access memory (RAM), flash memory, CD-ROMs, CD−Rs, CD+Rs, CD−RWs, CD+RWs, DVD-ROMs, DVD−Rs, DVD+Rs, DVD−RWs, DVD+RWs, DVD-RAMS, BD-ROMs, BD-Rs, BD-R LTHs, BD-REs, magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor-implemented method, the method comprising:
constructing a neuron array comprising a plurality of neuron modules;
mapping a target pattern to the neuron array;
adapting the neuron modules to the target pattern in response to a reception of the target pattern; and
training the neuron modules to cause the neuron array to mimic the target pattern.

2. The method of claim 1, wherein the adapting comprises activating the neuron modules in response to the reception of the target pattern and performing signal transmission between the neuron modules.

3. The method of claim 1, wherein
each of the neuron modules comprises any one or any combination of any two or more of a soma module, one or more axon modules, one or more synapse modules, and an external signal input/output module, and
the training comprises updating synaptic weights of the synapse modules.

4. The method of claim 3, wherein
the neuron modules are configured to operate in any one or any combination of any two or more of a visible mode, a hidden mode, a relay mode, and a block mode, and
the updating comprises:
determining whether each of the neuron modules operates in at least one of the visible mode and the hidden mode; and
updating, for each of neuron modules operating in the at least one of the visible mode and the hidden mode, the synaptic weights based on a time period from a point in time at which a spike signal is received from an adjacent neuron module to another point in time at which the corresponding neuron module outputs the spike signal.

5. The method of claim 4, wherein a neuron module of the neuron modules is configured to, when operating in the relay mode, store a direction in which the spike signal is input to the synapse module in a previous cycle, determine another direction in which the spike signal is to be transmitted in a subsequent cycle based on the direction in which the spike signal is input, and transmit the spike signal in the determined another direction.

6. The method of claim 1, wherein the constructing comprises determining at least one of connectivities of the plurality of neuron modules and a connection distance between the plurality of neuron modules.

7. The method of claim 1, wherein the mapping comprises:
constructing a subarray of the neuron array; and
determining operation modes of the neuron modules.

8. The method of claim 7, wherein
the operation mode comprises any one or any combination of any two or more of a visible mode, a hidden mode, a relay mode, and a block mode, and
the determining comprises determining an operation mode of one neuron module of the neuron modules included in the subarray to be the visible mode.

9. The method of claim 8, wherein the mapping comprises mapping the target pattern to the one neuron module operating in the visible mode.

10. A non-transitory computer-readable storage medium storing instructions that, when executed by a processor, configure the processor to perform the operating method of claim 1.

11. A device, comprising:
a processor configured to configure a neuron array, comprising a plurality of neuron modules, and map a target pattern to the neuron array,
wherein the neuron array is configured to adapt the neuron modules to the target pattern in response to a reception of the target pattern and train the neuron modules to mimic the target pattern.

12. The device of claim 11, wherein the neuron array is further configured to activate the neuron modules in response to the reception of the target pattern, and perform signal transmission between the neuron modules.

13. The device of claim 11, wherein
each of the neuron modules comprises any one or any combination of any two or more of a soma module, one or more axon modules, one or more synapse modules, and an external signal input/output module, and
the neuron array is further configured to update synaptic weights of the synapse modules.

14. The device of claim 13, wherein
the neuron modules are configured to operate in any one or any combination of any two or more of a visible mode, a hidden mode, a relay mode, and a block mode, and
the neuron array is further configured to determine whether each of the neuron modules operates in at least one of the visible mode and the hidden mode, and update, for each of neuron modules operating in the at least one of the visible mode and the hidden mode, the synaptic weights based on a time period from a point in time at which a spike signal is received from an adjacent neuron module to another point in time at which the corresponding neuron module outputs the spike signal.

15. The device of claim 11, wherein the neuron array is further configured to determine at least one of connectivities of the plurality of neuron modules and a connection distance between the plurality of neuron modules.

16. The device of claim 11, wherein
the neuron modules are configured to operate in any one or any combination of any two or more of a visible mode, a hidden mode, a relay mode, and a block mode, and
the processor is further configured to construct a subarray of the neuron array, determine an operation mode of one neuron module of the neuron modules included in the subarray to be the visible mode, and map the target pattern to the neuron module operating in the visible mode.

17. The device of claim 11, wherein the device is a smartphone.

18. A device, comprising:
a synapse module;
a soma module;
an axon module; and
an external signal input/output module,
wherein the synapse module is configured to transmit a synaptic weight value to the soma module based on an input spike signal received from a first axon module of a first adjacent neuron module,
the soma module is configured to accumulate signals received from the synapse module and the external signal input/output module, and output an output spike signal in response to a value of the accumulated signals being greater than or equal to a predetermined threshold value, and
the axon module is configured to transmit the output spike signal to a second synapse module of a second adjacent neuron module.

19. The device of claim 18, wherein the soma module comprises:
an accumulator configured to accumulate the signals received from the synapse module and the external signal input/output module; and
a comparator configured to compare the value of the accumulated signals to the threshold value.

20. The device of claim 18, wherein the synapse module comprises:
a counter configured to measure a timing for a predetermined time period from a point in time at which the input spike signal is received; and
a synaptic weight updater configured to update a synaptic weight based on the timing.

21. The device of claim 18, wherein the axon module comprises a delay buffer configured to receive the output spike signal from the soma module and transmit the received output spike signal to the second synapse module after a predetermined time period.

22. The device of claim 21, wherein the device is a smartphone.

23. A processor-implemented method of a neuron module circuit device, the method comprising:
transmitting, using a synapse module, a synaptic weight value to a soma module based on an input spike signal received from a first axon module of a first adjacent neuron module, accumulating signals received from the synapse module and the external signal input/output module,
outputting an output spike signal in response to a value of the accumulated signals being greater than or equal to a predetermined threshold value, and
transmitting the output spike signal to a second synapse module of a second adjacent neuron module.

24. The operating method of clam 23, further comprising comparing the value of the accumulated signals to the threshold value.

25. The operating method of clam 23, further comprising:
measuring a timing for a predetermined time period from a point in time at which the input spike signal is received; and
updating a synaptic weight based on the timing.

26. The operating method of clam 23, further comprising:
receiving the output spike signal from the soma module and transmit the received output spike signal to the second synapse module after a predetermined time period.
